(19) United States
(12) Patent Application Publication
(10) Pub. No.: US 2024/0328197 A1
(43) Pub. Date: Oct. 3, 2024

(54) MOTOR VEHICLE LOCK

(71) Applicant: KIEKERT AKTIENGESELLSCHAFT, Heiligenhaus (DE)

(72) Inventors: Peter SZEGENY, Engelskirchen (DE); Ömer INAN, Dorsten (DE); Holger SCHIFFER, Meerbusch (DE); Michael SCHOLZ, Essen (DE); Thomas SCHÖNENBERG, Burscheid (DE)

(73) Assignee: KIEKERT AKTIENGESELLSCHAFT, Heiligenhaus (DE)

(21) Appl. No.: 18/579,550

(22) PCT Filed: Jul. 19, 2022
(86) PCT No.: PCT/DE2022/100516

§ 371 Date: Jan. 16, 2024

(30) Foreign Application Priority Data
Jul. 28, 2021 (DE) 10 2021 119 651.5

(51) Int. Cl. E05B 17/00; E05B 15/16; E05B 85/26

(52) U.S. Cl. CPC E05B 17/007; E05B 15/1635; E05B 85/26

(57) ABSTRACT

A motor vehicle lock comprising a locking mechanism with a rotary latch and at least one pawl, wherein the locking mechanism parts are rotatably mounted on a stationary supporting body and wherein the supporting body forms a stop surface for at least one locking mechanism part, and the supporting body has at least in some sections a convex bearing surface for the locking mechanism part.

The invention relates to a motor vehicle lock comprising a locking mechanism with a rotary latch and at least one pawl, wherein the locking mechanism parts are rotatably mounted on a stationary supporting body and wherein the supporting body forms a stop surface for at least one locking mechanism part.

Motor vehicle locks are used where components arranged movably on the motor vehicle have to be securely held in their position during use of the motor vehicle. In principle, such motor vehicle locks are equipped with a locking mechanism consisting of a rotary latch and at least one pawl. The locking mechanism, the locking mechanism parts, and a solid lock case are also made of high-strength materials, preferably steels, since the motor vehicle lock must securely position and hold the movable component even in extreme situations. Often the motor vehicle locks are inserted in the moving component and work together with a lock holder fastened to the body. By a relative movement between the motor vehicle lock or the locking mechanism and the lock holder, the locking mechanism can be transferred into at least one latching position in which the pawl blocks the rotary latch which is in engagement with the lock holder. This design has proven itself in principle.

One development in the automotive industry is that the motor vehicle locks can be opened by an electric motor. The disadvantage to be overcome here is that in the closed position, i.e., a main rest position of the locking mechanism, high forces build up in the locking mechanism which have to be overcome by the electric motor drive in order to open the vehicle lock using an electric motor. The high closing forces substantially result from a sealing pressure between the movable component and the motor vehicle body. In particular in the case of very large movable components such as a sliding door, high closing forces must be maintained in the locking mechanism, which in turn leads to high forces when unlocking the locking mechanism. The electric motor drive must be able to overcome not only the forces resulting from the seal, but also forces that can occur in the event of an accident and deformation of the body, for example. In the event of an accident, the body can distort so that in the extreme case, there are no optimal closing ratios between the locking mechanism and the lock holder. In order to enable opening by an electric motor in the aforementioned cases, one approach is to reduce the frictional forces occurring in the locking mechanism during the opening or closing of the locking mechanism.

By way of example, DE 10-2016-215 336 A1 can be mentioned here, which discloses a way to reduce the frictional forces between the locking mechanism parts. In this case, a bearing cage is arranged in the locking mechanism and in particular between the rotary latch and the pawl, wherein, for example, a ball or a cylinder can be received in the bearing cage in order to ensure a rolling friction between pawl and rotary latch overall. The frictional forces are thereby reduced, and easy opening of the locking mechanism is made possible.

DE 10 2009 029 023 A1 discloses a locking mechanism with a support pawl and a pawl mounted on the support pawl. This design enables a tilting of the pawl and premature reduction of the forces acting on the locking mechanism, so that easy opening of the locking mechanism can be enabled.

The generic prior art provides another approach for reducing the frictional forces in the locking mechanism, wherein a bearing shaft of the pawl is designed as a stationary support body with an open bearing trough for receiving the pawl. A bearing surface of the pawl can thereby engage in the support body and reduce the engagement surface between the pawl and the bearing shaft of the pawl, whereby an optimization of the friction values can be achieved. This technique has proven successful in principle, but can be further improved with respect to robustness. This is where the invention starts from.

The invention is based on the technical problem of further developing a generic motor vehicle lock and in particular a motor vehicle door lock in such a way that robustness can be further increased, and the opening forces of the locking mechanism can be influenced.

The object is achieved by the features of independent claim 1. Advantageous embodiments of the invention are specified in the dependent claims. It should be noted that the embodiments described below are not limiting; rather, any possible variations of the features described in the description and the dependent claims are possible.

In order to solve the technical problem, a motor vehicle lock within the scope of the invention is characterized in that the motor vehicle lock has a locking mechanism with a rotary latch and at least one pawl, wherein the locking mechanism parts are mounted rotatably on a stationary support body, and wherein the support body forms a stop surface for at least one locking mechanism part, and the support body has an at least regionally convex bearing surface for the locking mechanism part. The design of the motor vehicle lock according to the invention now makes it possible to form the support body more generously and thus be able to dimension the bearing region larger for the locking mechanism part. The advantages of a low bearing friction are combined with the advantages of a possibility of a high surface force at the bearing point of the locking mechanism. On the one hand, due to the convex design of the bearing point, the bearing point itself can be enlarged overall, whereby higher forces can be absorbed, and on the other hand, minimal friction values can be expected between the locking mechanism part and the bearing point. The support body provides a friction-optimized bearing point for the locking mechanism with the convexly designed bearing surface. The friction between the locking mechanism part and the bearing point is reduced to a minimum, wherein at the same time, sufficient stability can be provided in the bearing point for the locking mechanism part. Due to the convex design of the bearing surface, the robustness of the bearing point can be improved since the bearing point can be enlarged overall in cross-section.

A motor vehicle lock according to the invention according to the invention is preferably a door lock, even more preferably a side door lock, but can be used wherever components arranged movably on the motor vehicle have to be secured. Mention should be made here of, for example, hood locks, sliding door locks, locks for covers or flaps, tailgates or doors, particularly all these components which must be securely held in position when the motor vehicle is used, or even comprise safety-relevant functions.

The locking mechanism has a rotary latch which can be held by means of a pawl in at least one latching position, the main latching position. However, locking mechanisms are also used which are equipped with a main latching and a pre-latching position, as are prescribed, for example, in side doors. The locking mechanism can furthermore be equipped with a pawl or with, for example, a pawl and a blocking lever. A blocking lever is used when an opening moment occurs in the locking mechanism in at least one latching position, preferably the main latching position, wherein the opening moment initiates an independent opening of the locking mechanism, wherein the independent opening can be prevented by means of the blocking lever. The invention is therefore not limited to a special locking mechanism, but provides an advantage where the locking mechanism is to be unlocked with reduced opening forces.

According to the invention, the locking mechanism parts and at least one locking mechanism part are mounted in a support body. The locking mechanism parts are usually held in a lock plate in bearing axles. As a result, the locking mechanism parts can move and engage in a pivotable or rotatable manner. According to the invention, a bearing surface is designed as a support surface and offers at least one stop surface for the locking mechanism. It is thus possible to limit the movement of the locking mechanism part by the bearing point itself, i.e., the support body. Advantages can thereby be combined. On the one hand, the sliding friction between the locking mechanism part and the bearing point can be reduced and, on the other hand, further stops for the locking mechanism can be dispensed with. The invention can be applied to all parts of the locking mechanism, wherein preferably the pawl can be supported by the convex support body according to the invention and can be provided with a stop.

If the support body has a bearing surface that is flush against the locking mechanism part, this results in an advantageous embodiment variant of the invention. A number of advantages can be achieved by placing the convex bearing surface flush against the locking mechanism component. On the one hand, a very precise configuration of the friction forces between the locking mechanism part and the bearing surface can be adjusted and, on the other hand, the noise conditions can be optimized. A continuous movement of the locking mechanism part can be ensured by a flush and thus flat application of the locking mechanism part to the bearing surface. The bearing surface consequently does not change during the movement of the locking mechanism part, whereby a continuous and consistently supported movement of the locking mechanism can be achieved. The same friction ratios and surface forces can thus be achieved in the locking mechanism, which in turn ensures that the locking mechanism moves smoothly. Flush here means that the locking mechanism part rests continuously against the bearing surface with a unchanging surface.

It can also be advantageous and form an embodiment of the invention if the support body has a stop surface for the locking mechanism. The supporting body can therefore have several functions. On the one hand, the support body serves as a bearing surface, that is to say as a friction and bearing surface during a movement of the locking mechanism part, and at the same time, the support body can provide at least one stop surface for the locking mechanism part. If the locking mechanism part is moved over the pawl and, for example, moved into a main latching position, the stop can be defined by the interaction between the locking mechanism parts. If, on the other hand, the locking mechanism part is moved out of the latching position and transferred into a release position, a separate additional support surface in the motor vehicle lock can be omitted by forming a stop surface on the support body. By forming the stop surface on the support body, a structurally simpler solution can thus be provided which provides a motor vehicle lock that has the same functionalities with a fewer number of components.

If the stop surface rests directly against the bearing surface, another advantageous embodiment variant can be provided. The locking mechanism slides in the movement over the bearing surface. In an end position, for example a main latching position, the locking mechanism part additionally comes into engagement with the stop surface. Another contact surface for the locking mechanism is thereby provided, whereby the surface pressure on the support body is reduced. In other words, the bearing surface and the contact surface offer a common support surface for absorbing the surface force in the locking mechanism part. The support body can thus serve as a bearing surface, as a stop surface, and for providing an enlarged surface for reducing the surface pressure on the support body. By combining the stop surface and the bearing surface which directly adjoin one another, a compactness of the structure of the motor vehicle lock can also be supported overall.

The bearing surface preferably has a uniform radius. By forming a fixed radius on the bearing surface, a structurally simple solution for the bearing of the locking mechanism part can be provided. It has been shown that a radius of 0.8 mm to approximately 1.5 mm, and preferably a radius of 1 mm, can provide a sufficient surface for bearing the locking mechanism part. By forming such a small radius for bearing the locking mechanism part, the friction between the locking mechanism part and the support body could be reduced by more than 20%. As a result, slight movements can also be achieved under loads in the locking mechanism, which in turn is advantageous for an electric motor drive when unlocking the locking mechanism.

If the support body forms a part of a pawl bearing, particularly smooth locking mechanisms could thereby be provided. Of course, the support body is not limited to the locking mechanism part, the pawl, but it has been shown that the formation of a support body according to the invention in the region of the pawl bearing can provide favorable force ratios when moving the locking mechanism parts. Due to the design according to the invention of the support body with the bearing surface and the stop surface, a friction-optimized pawl bearing with an integrated stop can be made available in minimum installation space.

Furthermore, if the locking mechanism part, in particular the pawl bearing, is equipped with a guide surface for the locking mechanism part, in particular the pawl bearing, the robustness of the support body and the locking mechanism can be further increased overall. A guide surface on the support body can preferably be formed diametrically opposite the bearing surface on the support body. Accordingly, the bearing surface on the one hand and the guide surface on the other hand can be used to move the locking mechanism part. If the bearing surface absorbs the corresponding force from the additional locking mechanism part, the guide surface can provide a smoothly moving and robust support body for moving the locking mechanism part. By reducing the bearing surface used to move the locking mechanism, a friction-optimized bearing point can be provided with a reduced friction coefficient, whereas a robust design of the locking mechanism part bearing can be achieved by forming a preferably diametrically arranged guide surface.

While radii of approx. 1 mm have proven to be advantageous in the region of the bearing surface, favorable results were achieved with radii of 4-6 mm, and preferably 5 mm, to form the guide surface with regard to the robustness of the bearing point for the locking mechanism part. The guide surface on the support body extends only regionally over the support body so that different geometries result on the diametrically opposite ends of the support body, wherein a symmetrical structure of the support body is advantageous overall. The symmetrical design and the arrangement of the bearing surface, the stop surface, and the opposite arrangement of the guide surface increase the cross-section of the support body by the convex design of the bearing surface and the guide surface. A cross-sectional enlargement of the support body provides a greater load-bearing cross-sectional area as a bearing surface for the locking mechanism part. In turn, the robustness of the locking mechanism can thereby be improved. However, the robustness of the locking mechanism is also improved in that the lever ratios in the locking mechanism as a whole change as a result of the increase in the cross-sectional area, namely in such a way that shorter levers can be provided in contrast to the prior art, whereby the supporting effect of the bearing point is improved and the lever ratios in the locking mechanism can be positively influenced.

In order to further increase the noise behavior and also the smooth movement of the locking mechanism parts, the invention proposes that the support body can be received in a recess in the locking mechanism, wherein the recess is lined or formed at least regionally with a bearing means, in particular a plastic. If the recess in the locking mechanism part and in particular the pawl is lined with a plastic, a low-noise and even more friction-optimized bearing of the locking mechanism part can be enabled. The plastic arranged in the region of the bearing point forms a sliding bearing for the locking mechanism part, whereby in particular the stop noises in the locking mechanism can be reduced. The ease of movement is also increased in that favorable friction partners can be combined between the locking mechanism part and the bearing point. Overall, the design according to the invention provides a friction-optimized bearing point for the locking mechanism parts, wherein the robustness can be increased overall by the design according to the invention.

The invention is explained in more detail below with reference to the accompanying drawings on the basis of a preferred embodiment. However, the principle applies that the exemplary embodiment does not limit the invention, but merely represents one embodiment. The features shown can be implemented individually or in combination with further features of the description as well as the claims—individually or in combination.

### IN THE FIGURES

FIG. 1 shows a motor vehicle lock according to the invention in its basic form; and

FIG. 2 shows an embodiment of the support body in the region of a bearing point of a pawl.

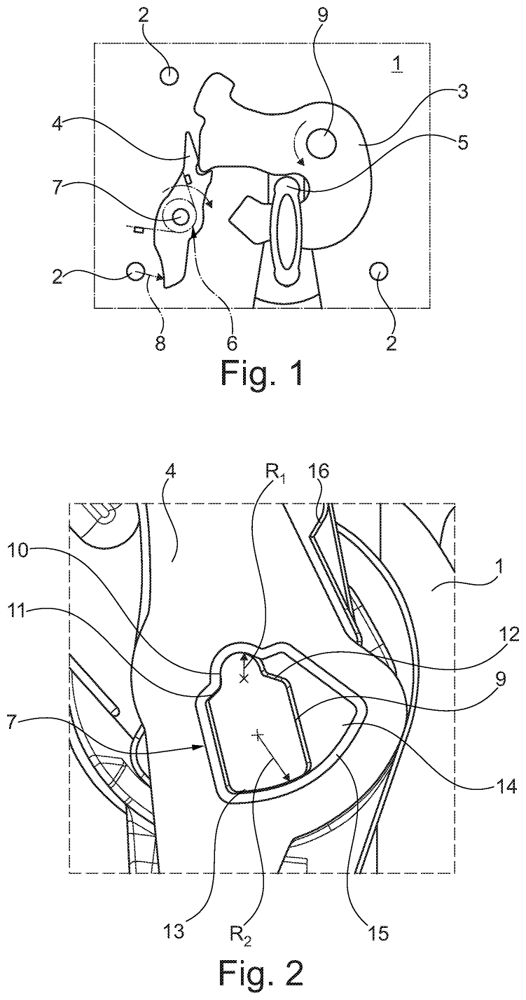

FIG. 1 shows a motor vehicle door lock in principle with the essential components for the explanation of the invention. The motor vehicle door lock is advantageously connected to a motor vehicle door (not shown). A base 1 is used for this, which is a metallic lock case 1 in the exemplary embodiment. The lock case 1 is connected to the motor vehicle door (not shown). Fastening screws (not shown) can serve for this purpose which engage in openings 2 in the lock case.

A locking mechanism 3, 4, which according to the exemplary embodiment is composed of a rotary latch 3 and a pawl 4, is mounted in the lock case 1. In principle, more than one pawl 4, i.e., a so-called multi-pawl locking mechanism, could also be realized, but this is not shown. The locking mechanism 3, 4 of the door lock or motor vehicle door lock interacts with a lock holder 5 which is connected to a motor vehicle body (not shown).

FIG. 1 shows the closed state of the locking mechanism 3, 4 in a basic form and merely for illustrating the structure of the design mechanism. In this closed state of a main latching position of the locking mechanism 3, 4, the lock holder 5 is held by means of the rotary latch, and is held in the main latching position shown here by means of the pawl 4. In this case, an additional pawl spring 6 ensures that the pawl 4 is equipped with a closing torque relative to its axis 7 indicated in FIG. 1 with an arrow. The rotary latch 3 also has a moment likewise indicated in FIG. 1 with an arrow, which can preferably be generated by a sealing pressure of the door but also by a rotary latch spring.

In addition, an electrical drive or opening drive 8, which acts on the pawl 4 with an opening moment or opening torque in the counterclockwise direction with respect to the shaft 7, can also be seen in FIG. 1. As soon as the pawl 4 is lifted out of its engagement with the rotary latch 3 with the aid of the opening drive 8, the rotary latch 3 can pivot open due to its opening torque and releases the locking pin 5.

FIG. 2 shows the design of a bearing point 7 according to the invention as a pawl bearing. The bearing point 7 comprises a support body 9, a bearing surface 10, two stop surfaces 11, 12, and a guide surface 13. A recess 14 is inserted In the pawl 4, wherein the recess 14 is additionally provided with a bearing means 15. Furthermore, the pawl 4 is provided at least in regionally with a plastic casing 16.

As can be clearly seen in FIG. 1, the pawl 4 rests flush against the bearing surface 10. In addition, the pawl 4 is held via the guide surface 13, whereby a play-free movement of the pawl 4 can be achieved. In the present exemplary embodiment, the bearing surface 10 has a radius R1 of 1 mm, whereas the guide surface 13 is equipped with a radius of 5 mm. The guide surface 13 extends only over a part of the support body 9 so that on the one hand, a secure guidance and contact of the bearing surface 10 and the guide surface 13 can be realized over the entire movement range of the pawl 4. In this embodiment, the bearing means 15 completely encloses the recess 14, but it is also conceivable that only the regions which are in engagement with the support body 9 are provided with a bearing means. The main latching position of the pawl 4 is again shown in FIG. 2 so that the stop surface 11 is also in engagement with the recess 14 or the bearing means 15. The stop surface 11 thus limits the movement of the pawl so that another stop for the pawl 4 can be dispensed with.

The recess 14 is enclosed by the bearing means 15. The pawl 4 moves along the bearing surface 10 and the guide surface 13 and in the recess 14 of the pawl 4. The recess 14 can be described as bell-shaped, so that overall one can speak of a bell bearing point. The bearing surface 10 and the guide surface 13 are designed convex so that overall, an enlarged cross-sectional area for the support body 9 results. The enlarged cross-sectional area increases the load-bearing cross-section of the bearing point 7 so that overall, the robustness of the locking mechanism 3, 4 can be increased. In addition to the increase in robustness, the bearing position 7 designed according to the invention can provide a friction-optimized locking mechanism part bearing position and, in the example, a pawl bearing point. Accordingly, a smoothly-operating bearing point 7 for the locking mechanism part 3, 4 or the pawl 4 is provided that can be opened by electric motor and is robust.

### LIST OF REFERENCE NUMBERS

1 Lock case
2 Opening
3, 4 Locking mechanism
3 Rotary latch
4 Pawl
5 Lock holder
6 Pawl spring
7 Axis, bearing point
8 Opening drive
9 Support body
10 Bearing surface
11, 12 Stop surface
13 Guide surface
14 Recess
15 Bearing means
16 Plastic casing
R1, R2 Radius

1. A motor vehicle lock comprising:
a locking mechanism having locking mechanism parts including at least a rotary latch and a pawl, and
a stationary supporting body, wherein the locking mechanism parts are rotatably mounted on the stationary supporting body, and
wherein the supporting body has a stop surface for at least one locking mechanism part of the locking mechanism parts, wherein the supporting body has at least in some sections a convex bearing surface for the at least one locking mechanism part.

2. The motor vehicle lock according to claim 1, wherein the convex bearing surface is flush with the at least one locking mechanism part whereby the at least one locking mechanism part rests continuously against the bearing surface during operation of the locking mechanism.

3. (canceled)

4. The motor vehicle lock according to claim 2, wherein the stop surface directly adjoins the convex bearing surface.

5. The motor vehicle lock according to claim 1, wherein the convex bearing surface has a uniform radius.

6. The motor vehicle lock according to claim 5, wherein the radius is 0.8 mm to 1.5 mm.

7. The motor vehicle lock according to claim 1, wherein convex bearing surface of the support body forms part of a pawl bearing point.

8. The motor vehicle lock according to claim 7, wherein the at least one locking mechanism part is the pawl, and the pawl bearing point has a guide surface for guiding the pawl.

9. The motor vehicle lock according to claim 8, wherein the guide surface has a radius of 3-6 mm.

10. The motor vehicle lock according to claim 1, wherein the support body is received in a recess of the at least locking mechanism part, and wherein the recess is formed at least regionally with a bearing.

11. The motor vehicle lock according to claim 8, wherein the guide surface has a radius of 4-5 mm.

12. The motor vehicle lock according to claim 8, wherein the convex bearing surface, the stop surface, and the guide surface together form a symmetrical shape.

13. The motor vehicle lock according to claim 10, wherein the bearing includes plastic.

14. The motor vehicle lock according to claim 10, wherein the bearing completely encloses the recess.

15. The motor vehicle lock according to claim 1, further comprising a lock plate that has bearing axles to hold the locking mechanism parts.
